(19) United States
(12) Patent Application Publication
(10) Pub. No.: US 2007/0176914 A1
(43) Pub. Date: Aug. 2, 2007

(54) Apparatus, method and medium displaying image according to position of user

(75) Inventors: Soo-hyun Bae, Yongin-si (KR); Hee-seob Ryu, Yongin-si (KR); Yong-beom Lee, Yongin-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/698,204

(22) Filed: Jan. 26, 2007

(30) Foreign Application Priority Data
Jan. 27, 2006 (KR) 10-2006-0008694

(51) Int. Cl. G09G 5/00

(52) U.S. Cl. 345/204

(57) ABSTRACT

An apparatus, method, and medium displaying an input image according to a position of a user, extracting a position vector of the user and warping the image input to both eyes of the user according to the extracted position vector in order to provide a stereoscopic image that is not perceived as warped by the user. The apparatus for displaying an input image according to the position of a user includes a position sensing unit to sense the position of the user, a change measurement unit to measure an amount of change in position of the user, and an image correction unit to correct the input image when the amount of change meets a predetermined threshold value.

### CROSS-REFERENCE TO RELATED APPLICATIONS

This application claims priority from Korean Patent Application No. 10-2006-0008694 filed on Jan. 27, 2006 in the Korean Intellectual Property Office, the disclosure of which is incorporated herein by reference in its entirety.

### BACKGROUND

1. Field

One or more embodiments of the present invention relate to an apparatus, method and medium for displaying an image according to the position of a user and, more particularly, to an apparatus, method and medium for displaying an input image according to the position of a user which can provide a stereoscopic image appropriate for the user by extracting a position vector of the user and warping the image input to both eyes of the user according to the extracted position vector.

2. Description of the Related Art

Digital televisions (TVs) have been introduced in response to demand for improved image quality. Digital TVs can provide not only improved image quality, but also more realistic images by offering different screen aspect ratios than conventional analog TVs.

Image quality is an important factor in two-dimensional (2D) images, and consumer demand for 3D stereoscopic images has recently increased. Accordingly, research in the area of 3D stereoscopic images has been increasing.

Stereoscopic image displaying techniques may include display techniques in which a viewer has to wear stereoscopic glasses to view a stereoscopic image, and glassless display techniques, which allow a viewer to view a displayed stereoscopic image without using glasses. The display methods using glasses include, for example, a polarization operation and a time division operation, and the glassless display operations include, for example, a parallax barrier operation and a lenticular operation.

Conventional 3D stereoscopic image broadcasting systems (hereinafter, a 3D stereoscopic image is referred to as a stereoscopic image) have been developed for years in Japan, Europe, the United States and the like, but have not been commercialized, mainly due to visual fatigue and the inconvenience of having to wear stereoscopic glasses.

Major causes of the visual fatigue that occurs in stereoscopic image systems include an accommodation-convergence breakdown and crosstalk.

The accommodation-convergence breakdown does not occur when a user views an object in the real world since accommodation and convergence are intrinsically linked in the real world. Therefore, in the real world, the user can perceive 3D depth without eye fatigue. However, when the user views a stereoscopic image through a conventional stereoscopic image system, the accommodation-convergence breakdown occurs due to a large disparity between the point at which the eyes of the user are focused and the point at which the eyes of the user are converged. In other words, while the eyes of the user are focused at the plane of a screen, they are also converged at a different 3D location, which is produced by the disparity on the screen.

In addition, even when a portion of a displayed image has a depth that is outside a depth-of-focus (DOF) range of the user's eyes, the portion is clearly viewed. Consequently, a dual image created here causes eye fatigue.

Also, crosstalk occurs because left and right images are not accurately separated in a stereoscopic image system. Crosstalk may be caused by the incomplete image conversion of stereoscopic glasses or an afterglow effect of a light-emitting factor on a monitor. Even when the left and right images are accurately separated, the degree to which they are separated varies according to the position of a user. Therefore, crosstalk may still be present.

Also, when a user's viewing angle is not perpendicular to a display surface of the stereoscopic image system, the user may perceive an image as being warped.

Korean Patent Publication No. 2002-014456 discusses a technique of correcting deformation of a stereoscopic imagewhere a display of a stereoscopic image is partially deformed as the distance between the left and right eyes of a viewer changes is corrected. The correction occurs by selectively magnifying and reducing the left and right images in combination with selectively moving the left and right images.

However, according to this correcting technique, images input to the left and right eyes of a user are changed to have different sizes. Therefore, it is difficult to use this technique to provide a stereoscopic image according to an angle formed by a display surface and a visual angle of the user. Furthermore, this technique fails to eliminate the inconvenience of having to wear stereoscopic glasses.

In this regard, a method of displaying a stereoscopic image, which can reduce crosstalk and warping, and eliminate the inconvenience of having to wear stereoscopic glasses, is needed.

### SUMMARY

One or more embodiments of the present invention provide an apparatus method and medium displaying a stereoscopic image having reduced warping to a user by extracting a position vector of the user and warping an image input to both eyes of the user according to the extracted position vector.

One or more embodiments of the present invention provide an apparatus method and medium to minimize overall system modification and reduce cost by adding a separate unit for displaying a stereoscopic image to an image display system.

Additional aspects and/or advantages of the invention will be set forth in part in the description which follows and, in part, will be apparent from the description, or may be learned by practice of the invention.

To achieve at least the above and/or other aspects and advantage, one or more embodiments of the present invention include an apparatus for displaying an input image according to a position of a user. The apparatus includes at least one position sensing unit to sense the position of the user, a change measurement unit to measure an amount of change in the position of the user, and an image correction unit to correct the input image when the amount of change meets a predetermined threshold value.

To achieve at least the above and/or other aspects and advantage, one or more embodiments of the present invention include a method of displaying an input image according to the position of a user. The method includes sensing the position of the user, measuring an amount of change in position of the user, correcting the input image when the amount of change exceeds a predetermined threshold value, and displaying the corrected image.

To achieve at least the above and/or other aspects and advantage, one or more embodiments of the present invention include an apparatus to correct an image according to a position of a user. The apparatus includes a change measurement unit to measure an amount of position change in the position of the user and a direction of the position change, a warping matrix generator to generate a warping matrix according to the amount and the direction of the position change of the user, the warping matrix comprising a series of vectors for shifting points on the image according to the amount and the direction of the position change of the user, and a warping performer to warp the image using the warping matrix if the amount of position change of the user meets a predetermined threshold.

### BRIEF DESCRIPTION OF THE DRAWINGS

These and/or other aspects and advantages of the invention will become apparent and more readily appreciated from the following description of embodiments, taken in conjunction with the accompanying drawings of which:

FIG. 1 illustrates a stereoscopic image displaying method, according to one or more embodiments of the present invention;

FIG. 2 illustrates a stereoscopic imaging apparatus, according one or more embodiments of the present invention;

FIG. 3 illustrates an image correction unit of FIG. 2, according to one or more embodiments of the present invention;

FIGS. 4A and 4B illustrates an image correction method, according to one or more embodiments of the present invention; and

FIG. 5 illustrates the operation of the stereoscopic imaging apparatus of FIG. 2, according to one or more embodiments of the present invention.

### DETAILED DESCRIPTION OF EMBODIMENTS

Reference will now be made in detail to one or more embodiments of the present invention, examples of which are illustrated in the accompanying drawings, wherein like reference numerals refer to like elements throughout. Embodiments are described below to explain the present invention by referring to the figures.

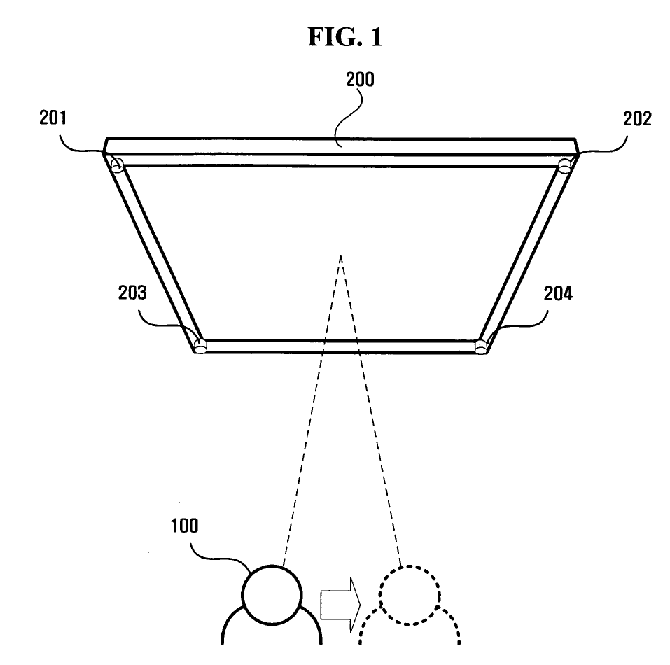

FIG. 1 illustrates a method of displaying a stereoscopic image, according to one or more embodiments of the present invention. Referring to FIG. 1, an apparatus for displaying a stereoscopic image (hereinafter referred to as a stereoscopic imaging apparatus 200) according to the position of a user 100 may sense motion of the user 100 and warp an image according to the extent of the sensed motion.

To sense the motion of the user 100, the stereoscopic imaging apparatus 200 may include at least one of position sensing units 201 through 204. The position sensing units 201 through 204 which sense the position of the user 100 may include, for example, infrared cameras, digital cameras, or ultrasonic transmitters/receivers.

In an embodiment, when the position sensing units 201 through 204 are infrared cameras or digital cameras, the distance and motion of the user 100 may be sensed using the shape of the user 100 sensed by the infrared cameras or the digital cameras. When the position sensing units 201 through 204 are ultrasonic transmitters/receivers, at least one of ultrasonic waves transmitted from the ultrasonic transmitters/receivers may be reflected off the user 100, and the reflected ultrasonic wave received and analyzed by the ultrasonic transmitters/receivers. In so doing, the distance and motion of the user 100 can be sensed.

In addition, the user 100 may wear stereoscopic glasses to view a stereoscopic image. In this case, the motion of the user 100 may be sensed by, for example, a terrestrial magnetism sensor or an inertia sensor included in the stereoscopic glasses. The sensed motion of the user 100 may then be transmitted to the stereoscopic imaging apparatus 200 through a predetermined communication unit, for example. Consequently, the position sensing units 201 through 204 of the stereoscopic imaging apparatus 200 can sense the motion of the user 100.

Generally, when the position of the user 100 changes, the user 100 perceives a displayed stereoscopic image as being warped. To reduce this perceived warping, the stereoscopic imaging apparatus 200 may artificially warp the displayed stereoscopic image according to the motion of the user 100 and may display the artificially warped stereoscopic image. Accordingly, the user 100 can view a stereoscopic image that appears un-warped, i.e. the artificially warped stereoscopic image does not appear distorted, despite the motion of the user.

Artificial warping of a stereoscopic image, that is, image correction, may be performed using a warping matrix. The warping matrix reflects an initial position of a user and a position of the user after the user moves, and may be applied to a displayed stereoscopic image. Since a stereoscopic image is artificially warped using the warping matrix, the user 100 can view a normal stereoscopic image regardless of his or her motion.

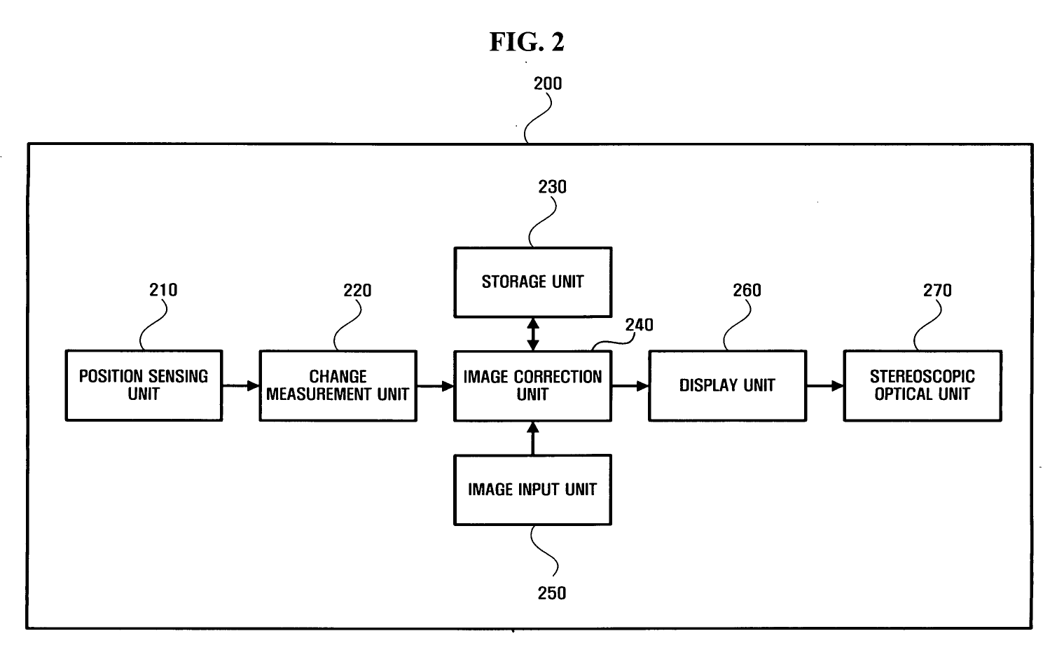

FIG. 2 illustrates a stereoscopic imaging apparatus 200, according one or more embodiments of the present invention. The stereoscopic imaging apparatus 200 may include a position sensing unit 210, a change measurement unit 220, a storage unit 230, an image correction unit 240, an image input unit 250, a display unit 260, and a stereoscopic optical unit 270, for example.

The position sensing unit 210 senses the position of a user. To this end, the position sensing unit 210 may include at least one position sensor. Here the position sensors may include infrared cameras, digital cameras, or ultrasonic transmitters/receivers, for example.

For example, when the position sensors are infrared cameras or digital cameras, the distance and motion of the user may be sensed using the shape of the user sensed by the infrared cameras or the digital cameras. When the position sensors are ultrasonic transmitters/receivers, at least one of ultrasonic waves transmitted from the ultrasonic transmitters/receivers is reflected by the user, and the reflected ultrasonic wave may be received again and analyzed by the ultrasonic transmitters/receivers. In so doing, the distance and motion of the user may be sensed.

The change measurement unit 220 may measure an amount of position change of the user. The amount of position change may include a change in the distance between the user and the stereoscopic imaging apparatus 200, as well as amounts of vertical and horizontal movements of the user. Here, the change measurement unit 220 may identify whether the amount of position change of the user received from the position sensing unit 210 meets a predetermined threshold value. Alternatively, other ways of defining the threshold are available such as determining whether the predetermined threshold value is exceeded, for example. When the amount of position change of the user meets the predetermined threshold value, for example, the change measurement unit 220 forwards a motion vector of the user to the image correction unit 240. Conversely, when the amount of position change of the user does not meet the predetermined threshold value, for example, the stereoscopic imaging apparatus 200 may terminate its operation. In one embodiment, the threshold value varies according to the performance of the display unit 260 and may be determined by the user.

The image input unit 250 may receive a 2D image from the storage unit 230 or from a predetermined communication unit over a network, for example. The 2D image may be an image for both eyes of the user, which can be converted into a 3D stereoscopic image. In other words, the 2D image may include left-eye and right-eye images.

The image correction unit 240 corrects the 2D image received from the image input unit 250. The image correction unit 240 may correct the 2D image according to the amount of position change of the user measured by the change measurement unit 220. In this case, the image correction unit 240 may correct the 2D image using the warping matrix.

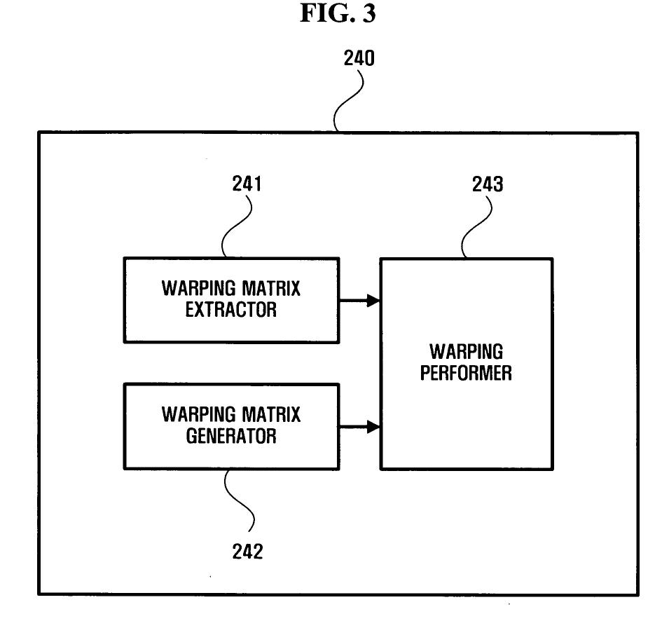

Alternatively, the image correction unit 240 may correct the 2D image using a warping matrix stored in the storage unit 230, for example. In other words, the image correction unit 240 searches the storage unit 230 for an amount of position change similar to the amount of change of the user, as received from the change measurement unit 220. When the image correction unit 240 finds an amount of position change similar to that of the user, it extracts a corresponding warping matrix stored in the storage unit 230 and applies the extracted warping matrix to the 2D image. The image correction unit 240 will be described in more detail later with reference to FIG. 3.

The storage unit 230 may store a warping matrix corresponding to the amount of position change of the user. When the amount of position change of the user meets the predetermined threshold value, it denotes that the warping matrix stored in the storage unit 230 has been created by the image correction unit 240. Thus, the warping matrix can be modified by the user. In other words, the user can apply a certain warping matrix to a displayed image and adjust a vector amount of the displayed image.

In one embodiment, e.g. when the storage unit 230 is used, the storage unit 230 may be a module capable of receiving and outputting information, such as a hard disk, a flash memory, a compact flash (CF) card, a secure digital (SD) card, a smart media (SM) card, a multimedia card (MMC), and a memory stick, for example. The storage unit 230 may be included in the stereoscopic imaging apparatus 200, or in a separate apparatus.

The display unit 260 may display the 2D image corrected by the image correction unit 240. In this case, the 2D image may not be a general 2D image but a 2D image which can be converted into a 3D image. The 2D image may include depth cues for 3D depth perception with both eyes. The depth cues may be optical information such as a binocular disparity and motion parallax, for example.

The 2D image displayed on the display unit 260 may also include monocular depth cues for 3D depth perception, as well as binocular depth cues. Monocular depth cues include, for example, reflection by light, shadowing, relative sizes of objects at different distances, overlapping of objects, texture gradient, which refers to an effect in which textures of closer objects look clearer, aerial perspective, which refers to an effect in which objects at greater distance look hazy, and motion parallax, which refers to an effect in which objects at a closer distance appear to move faster, and perspective.

The display unit 260 may be a module including an image display which can display an input image signal. In an embodiment, the image display may be a cathode ray tube (CRT), a liquid crystal display (LCD), a light-emitting diode (LED), an organic light-emitting diode (OLED), or a plasma display panel (PDP), for example. The display unit 250 may display a 2D image in response to the input image signal.

The stereoscopic optical unit 270 converts the 2D image received from the display unit 260 into a 3D stereoscopic image. In other words, the stereoscopic optical unit 270 may divide the 2D image into a left-eye image and a right-eye image and project the left-eye image into the left eye of the user and the right-eye image into the right eye of the user, so that the user can perceive a stereoscopic image.

Such an operation of the stereoscopic optical unit 270 may be performed using a parallax barrier method or a lenticular method, for example.

The parallax barrier method refers to an operation of displaying a stereoscopic image using a parallax barrier. A parallax barrier refers to a plate with slit-shaped openings aligned parallel to one another. When left-eye and right-eye images or multi-eye images are alternated on a rear surface of the parallax barrier at regular intervals, a stereoscopic image can be viewed with the naked eye through the openings from a certain distance.

The lenticular method refers to a method of displaying a stereoscopic image using a lenticular sheet with an array of small lenses, instead of barriers, which divide a 2D image into left-eye and right-eye images or multi-eye images. Since the left-eye and right-eye images divided from the 2D image can be viewed through the stereoscopic optical unit 270, the user can view a stereoscopic image without wearing stereoscopic glasses.

Alternatively, the stereoscopic optical unit 270 may generate a stereoscopic image, which can be viewed using stereoscopic glasses, by dividing the 2D image into the left-eye and right-eye images using a polarization method and a time division method.

FIG. 3 is a detailed block diagram of the image correction unit 240 of FIG. 2. Referring to FIG. 3, the image correction unit 240 may include a warping matrix extractor 241, a warping matrix generator 242, and a warping performer 243, for example.

The warping matrix generator 242 generates a warping matrix corresponding to the amount of position change of a user. A warping matrix may include motion vectors corresponding to the motion of the user with respect to a reference vector at an initial position of the user. Values of the motion vectors may vary according to a direction in which the user views a stereoscopic image and a direction in which the user moves.

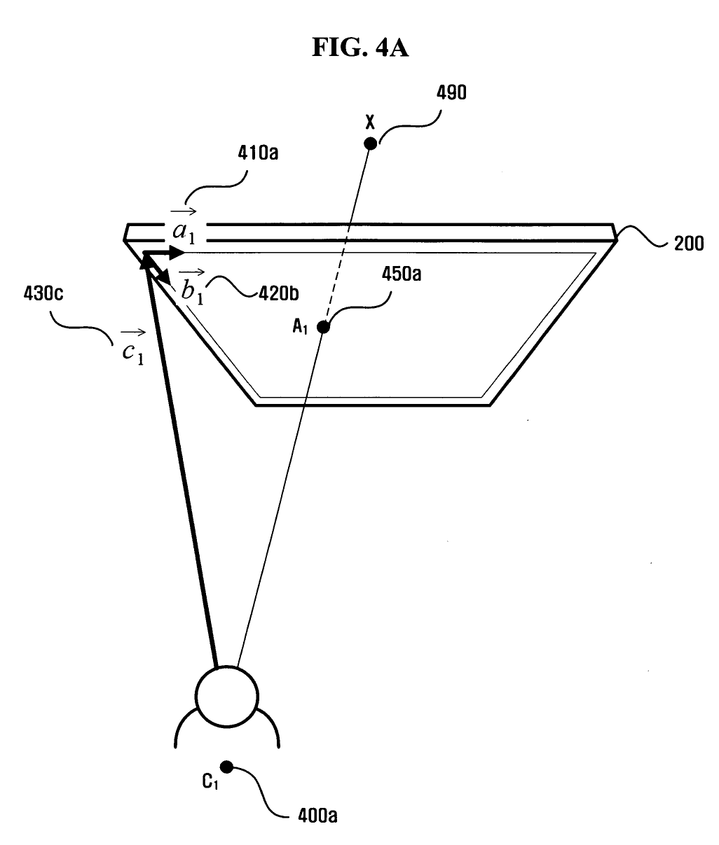

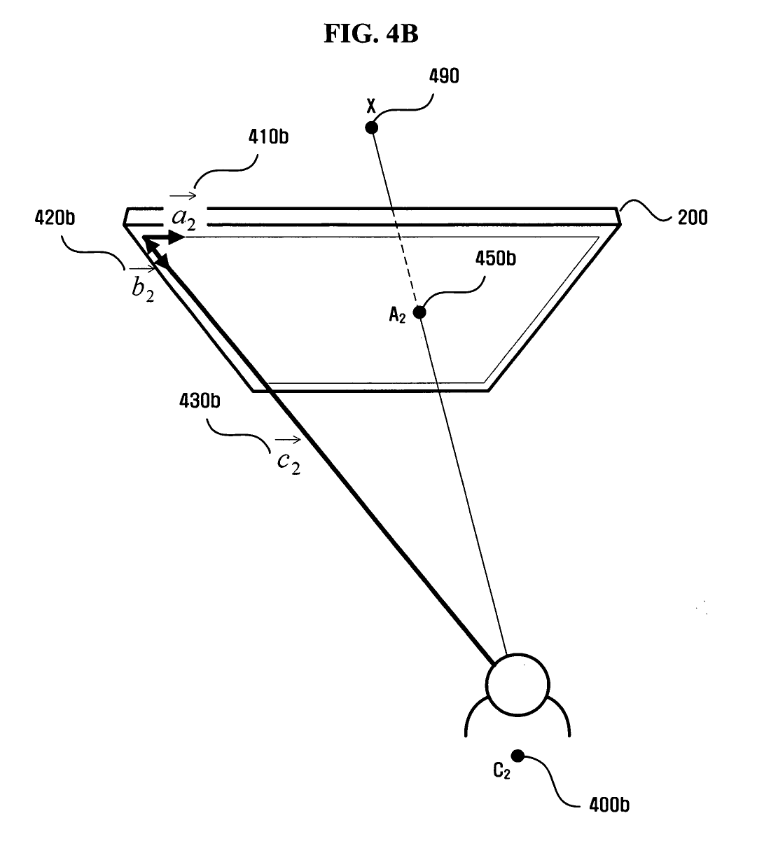

The generated warping matrix may be stored in the storage unit 230 to correspond to the amount of position change of the user, for example. The warping matrix will be described in more detail later with reference to FIG. 4.

The warping performer 243 may warp a binocular image included in an input image using a warping matrix: In other words, the warping performer 243 may calculate a warping vector of the binocular image and thus correct the input image. In this case, the warping matrix may be generated by the warping matrix generator 242, or received from the storage unit 230, for example. In other words, the warping performer 243 may perform a warping operation using a warping matrix corresponding to the amount of position change of the user among warping matrices stored in the storage unit 230.

The warping matrix extractor 241 may extract the warping matrix corresponding to the amount of position change of the user from the storage unit 230. When the warping matrix corresponding to the amount of position change of the user is stored in the storage unit 230, the warping matrix extractor 241 may extract the warping matrix and forward the extracted warping matrix to the warping performer 243. When the warping matrix corresponding to the amount of position change of the user is not stored in the storage unit 230, the warping performer 243 may give control to the warping matrix generator 242 to generate the warping matrix corresponding to the input amount of position change of the user.

FIGS. 4A and 4B illustrate an image correction method according to one or more embodiments of the present invention. Reference vectors 410a, 420a and 430a at an initial position 400a of a user and motion vectors 410b, 420b and 430b according to the motion of the user are illustrated in FIGS. 4A and 4B, as an example.

In FIG. 4A, C₁ indicates the initial position 400a of the user, \vec{a}₁ 410a and \vec{b}₁ 420a indicate horizontal or vertical reference vectors with respect to the user, and \vec{c}₁ indicates a reference vector with respect to the user's gaze at the top left part of the display unit 260.

An image displayed by the stereoscopic image 200 may be a stereoscopic image having depth. At spot C₁, i.e., the initial position 400a of the user, object X (490) may be mapped at spot A₁ (450a) in a display region.

When the user moves to spot C₂ (400b) of FIG. 4B, object X 490 may be mapped at spot A₂ (450b) in the display region, for example, which results in the warping of the image. Therefore, the image correction unit 240 artificially alters the image by moving the image at spot A₁ (450a) to spot A₂ (450b) in order to reduce the user's perceived warping of the image.

In FIG. 4B, \vec{a}₁ 410b and \vec{b}₁ 420b indicate horizontal or vertical motion vectors with respect to the user, and \vec{c}₁ 430b indicates a motion vector with respect to the user's gaze toward the top left part of the display unit 260.

A warping matrix W may be defined as below, for example.

$$\begin{matrix}\text{Equation 1:} & \\ W = [ \begin{matrix}{w}_{11} & {w}_{12} & {w}_{13} & {w}_{14} \\ {w}_{21} & {w}_{22} & {w}_{23} & {w}_{24} \\ {w}_{31} & {w}_{32} & {w}_{33} & {w}_{34}\end{matrix} ] . & ( 1 )\end{matrix}$$

Here, each component of the warping matrix may be defined as below, for example.

Equation 2:

w₁₁=\vec{a}₁E(\vec{b}₂s \vec{c}₂)w₂₁=\vec{a}₁E(\vec{c}₂s\vec{a}₂) w₃₁=\vec{a}₁E(\vec{a}₂s\vec{b}₂) w₁₂=\vec{b}₁E(\vec{b}₂s\vec{c}₂)w₂₂=\vec{b}₁E(\vec{c}₂s\vec{a}₂)w₃₂=\vec{b}₁E (\vec{a}₂s\vec{b}₂) w₁₃=\vec{c}₁E(\vec{b}₂s\vec{c}₂)w₂₃=\vec{c}₁E(\vec{c c}₁E(\vec{c}₂s\vec{a}₂)w₃₃=\vec{c}₁E(\vec{a}₂s\vec{b}₂) w₁₄=(C₁−C₂)E(\vec{b}₂s\vec{c}₂)w₂₄=(C₁−C₂) E(\vec{c}₂s\vec{a}₂)w₃₄=(C₁−C₂)E(\vec{a}₂s\vec{b}₂) (2).

According to Equation 2, a value of each component of the warping matrix may vary according to the amount and direction of position change of the user.

Assuming, as an example, that initial coordinates of the image displayed in the display region are (u₁, v₁) and that an imbalance in the display region caused by the movement of the user is δ(u₁, v₁), the amount of position change of the user may be given by the below, for example.

$$\begin{matrix}\text{Equation 3:} & \\ {δ ( {u}_{1} , {v}_{1} )}_{new} = \frac{‖ {u}_{1} \vec{{a}_{1}} + {v}_{1} \vec{{b}_{1}} + \vec{{c}_{1}} ‖}{\vert {C}_{1 x} - {C}_{2 x} \vert} , & ( 3 )\end{matrix}$$

Here, δ(u₁, v₁)_{new} denotes an imbalance caused by the position change of the user, and C_{1X} and C_{2X} respectively indicate an initial position and a subsequent position of the user in a horizontal direction.

When the imbalance before the position change of the user is δ(u₁, v₁)_{old}, if |δ(u₁, v₁)_{new}−δ(u₁, v₁)_{old}|,that is, the amount of position change of the user, meets a predetermined threshold value, the image correction unit 240 may correct the image using the warping matrix of Equation 2, for example. In this case, since δ(u₁, v₁)_{old} can be regarded as zero, image correction may be determined based on whether δ(u₁, v₁)_{new} meets the predetermined threshold value.

In Equation 3, the amount of position change of the user in the horizontal direction is taken into consideration. However, the vertical direction and the distance between the user and the stereoscopic imaging apparatus 200 can also be considered to calculate the amount of position change of the user.

Accordingly, assuming that coordinates of the image determined based on the position change of the user is (u₂, v₂), the determined coordinates (u₂, v₂) of the image may be defined as below, for example.

$$\text{Equation 4:} \\ {u}_{2} = \frac{{w}_{11} {u}_{1} + {w}_{12} {v}_{1} + {w}_{13} + {w}_{14} δ ( {u}_{1} , {v}_{1} )}{{w}_{31} {u}_{1} + {w}_{32} {v}_{1} + {w}_{33} + {w}_{34} δ ( {u}_{1} , {v}_{1} )} \\ {v}_{2} = \frac{{w}_{21} {u}_{1} + {w}_{22} {v}_{1} + {w}_{23} + {w}_{24} δ ( {u}_{1} , {v}_{1} )}{{w}_{31} {u}_{1} + {w}_{32} {v}_{1} + {w}_{33} + {w}_{34} δ ( {u}_{1} , {v}_{1} )} \qquad$$

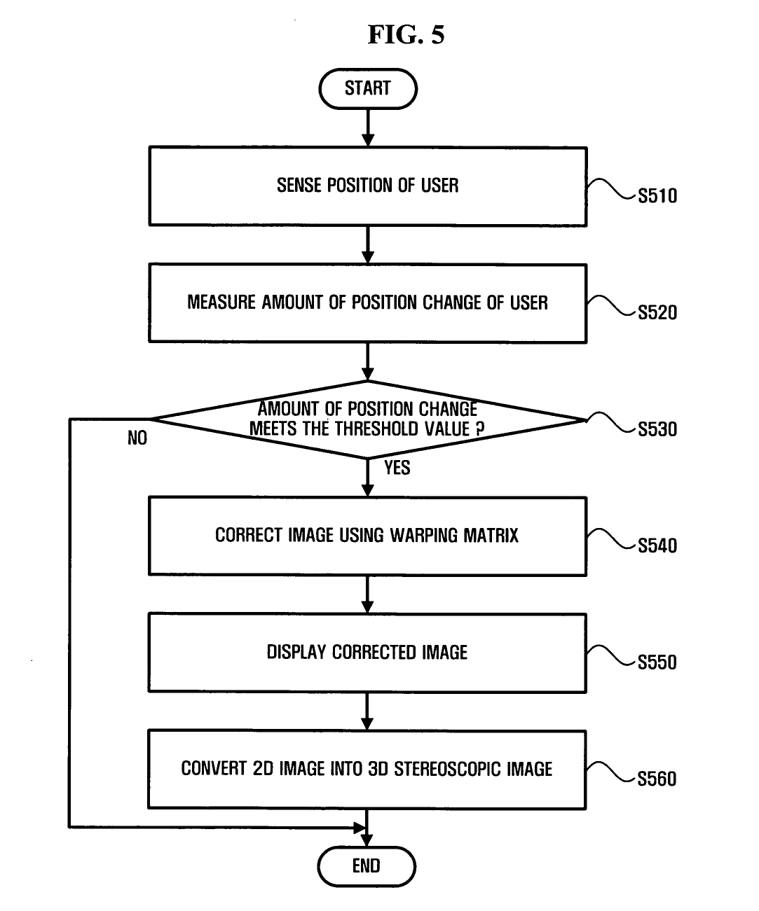

FIG. 5 illustrates the operation of the stereoscopic imaging apparatus 200, according to one or more embodiments of the present invention.

To display an image according to the position of a user, the position sensing unit 210 included in the stereoscopic imaging apparatus 200, for example, may sense the position of the user in operation S510.

In an embodiment, the position sensing unit 210 may sense the position of the user using one or more of an infrared camera, a digital camera, and an ultrasonic transmitters/receiver, for example.

The position sensing unit 210 may forward the sensed position of the user to the change measurement unit 220, and the change measurement unit 220, for example, may measure the amount of position change of the user in operation S520 and determine whether the measured amount of position change of the user meets a predetermined threshold value in operation S530.

When the amount of position change of the user meets the predetermined threshold value, the motion vectors (\vec{a}₂, \vec{b}₂, \vec{c}₂) of the user may be forwarded to the image correction unit 240. When the amount of position change of the user does not meet the predetermined threshold value, the operation of the stereoscopic imaging apparatus 200 may be terminated. The threshold value may vary according to the performance of the display unit 260 and may be determined by the user.

The image correction unit 240, for example, which receives the motion vectors of the user, may correct an image using a warping matrix in operation S540. In other words, vertical and horizontal motion vectors with respect to the user may be calculated to correct the image. The warping matrix may be generated by the image correction unit 240 based on reference vectors and motion vectors of the user or may be received from the storage unit 230. In other words, the image correction unit 240 may search the storage unit 230 for a warping matrix corresponding to the amount of position change of the user. When the warping matrix corresponding to the amount of position change of the user is stored in the storage unit 230, the image correction unit 240 may correct the image using the warping matrix. Otherwise, the image correction unit 240 may generate a warping matrix using motion vectors received from the storage unit 230.

Thus, in an embodiment, the generated warping matrix may be stored in the storage unit 230 to correspond to the amount of position change of the user.

The corrected image may be forwarded to the display unit 260, and the display unit 260 may display the corrected image in operation S550. Here, for example, the image displayed on the display unit 260 is a 2D image which can be converted into a 3D image.

The displayed 2D image may be forwarded to the stereoscopic optical unit 270, which may then convert the received 2D image into a 3D image in operation S560. The stereoscopic optical unit 270 may convert the displayed 2D image into a 3D stereoscopic image using at least one of the parallax barrier operation, the lenticular operation, the polarization operation, and the time division operation, for example. Accordingly, the user can view the 3D stereoscopic image, which is converted from the corrected 2D image, by wearing or not wearing stereoscopic glasses according to the display methodology.

In addition to this discussion, one or more embodiments of the present invention can also be implemented through computer readable code/instructions in/on a medium, e.g., a computer readable medium, to control at least one processing element to implement any above described embodiment. The medium can correspond to any medium/media permitting the storing and/or transmission of the computer readable code.

The computer readable code can be recorded/transferred on a medium in a variety of ways, with examples of the medium including magnetic storage media (e.g., ROM, floppy disks, hard disks, etc.), optical recording media (e.g., CD-ROMs, or DVDs), and storage/transmission media, as well as through the Internet, for example. Here, the medium may further be a signal, such as a resultant signal or bitstream, according to one or more embodiments of the present invention. The media may also be a distributed network, so that the computer readable code is stored/transferred and executed in a distributed fashion. Still further, as only an example, the processing element could include a processor or a computer processor, and processing elements may be distributed and/or included in a single device.

As described above, an image displaying apparatus, method, and medium, according to the position of a user, and according to one or more embodiments of the present invention, provides at least the following advantages.

The image displaying apparatus, method and medium may extract a position vector of a user and warp an image input to both eyes of the user according to the extracted position vector in order to provide a stereoscopic image appropriate for the user. Consequently, discomfort felt by the user due to perceived warping of a stereoscopic image can be reduced.

In addition, since a separate unit displaying a stereoscopic image may be added to a conventional image display system, the overall system modification may be minimized and costs saved.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. An apparatus to display an input image according to a position of a user, the apparatus comprising:
at least one position sensing unit to sense the position of the user;
a change measurement unit to measure an amount of change in position of the user; and
an image correction unit to correct the input image when the amount of change meets a predetermined threshold value.

2. The apparatus of claim 1, wherein the change measurement unit measures the distance from the user to the image displaying apparatus and amounts of vertical and horizontal movements of the user.

3. The apparatus of claim 1, wherein the image correction unit comprises:
a warping matrix generator to generate a warping matrix according to the amount of change; and
a warping performer to warp a binocular image included in the input image using the warping matrix.

4. The apparatus of claim 3, wherein the warping performer extracts a warping matrix corresponding to the amount of change among warping matrices stored in a storage unit and warps the binocular image using the extracted warping matrix.

5. The apparatus of claim 4, further comprising a warping matrix extractor to extract the warping matrix from the storage unit corresponding to the amount of change.

6. The apparatus of claim 3, further comprising a storage unit to store the warping matrix corresponding to the amount of change.

7. The apparatus of claim 1, further comprising a stereoscopic optical unit to convert the displayed image into a three-dimensional (3D) stereoscopic image.

8. The apparatus of claim 7, wherein the stereoscopic optical unit converts the displayed image into the 3D stereoscopic image using at least one of a parallax barrier operation, a lenticular operation, a polarization operation, and a time division operation.

9. The apparatus of claim 1, further comprising a display unit to display the corrected image.

10. A method of displaying an input image according to a position of a user, the method comprising:
sensing the position of the user;
measuring an amount of change in position of the user; and
correcting the input image when the amount of change meets a predetermined threshold value.

11. The method of claim 10, wherein the measuring of the amount of change comprises measuring a distance from the user to an image displaying apparatus and amounts of vertical and horizontal movements of the user.

12. The method of claim 10, wherein the correcting of the input image comprises:
generating a warping matrix according to the amount of change; and
warping a binocular image of the input image using the warping matrix.

13. The method of claim 12, wherein the warping of the binocular image comprises extracting a warping matrix corresponding to the amount of change among predetermined warping matrices and warping the binocular image using the extracted warping matrix.

14. The method of claim 13, further comprising extracting the predetermined warping matrix corresponding to the amount of change.

15. The method of claim 12, further comprising storing the predetermined warping matrix corresponding to the amount of change.

16. The method of claim 10, further comprising converting the displayed image into a 3D stereoscopic image.

17. The method of claim 16, wherein the converting of the displayed image comprises converting the displayed image into the 3D stereoscopic image using at least one of a parallax barrier operation, a lenticular operation, a polarization operation, and a time division operation.

18. The method of claim 10, further comprising displaying the corrected image.

19. At least one medium comprising computer readable code to control at least one processing element to implement the method of claim 10.

20. An apparatus to correct an image according to a position of a user, the apparatus comprising:
a change measurement unit to measure an amount of position change in the position of the user and a direction of the position change;
a warping matrix generator to generate a warping matrix according to the amount and the direction of the position change of the user, the warping matrix comprising a series of vectors for shifting points on the image according to the amount and the direction of the position change of the user; and
a warping performer to warp the image using the warping matrix if the amount of position change of the user meets a predetermined threshold.
